(19) United States
(12) Patent Application Publication
(10) Pub. No.: US 2026/0122596 A1
(43) Pub. Date: Apr. 30, 2026

(54) MANAGING NON-TERRESTRIAL NETWORK ACCESS USING AN EQUIPMENT INFORMATION REGISTRY

(71) Applicant: T-Mobile USA, Inc., Bellevue, WA (US)

(72) Inventors: Zoltan Homorodi, Bellevue, WA (US); Nilesh Ranjan, Sammamish, WA (US); Savitha Venkata Rao, Sammamish, WA (US)

(21) Appl. No.: 18/934,032

(22) Filed: Oct. 31, 2024

(51) Int. Cl. H04W 60/04; H04W 8/04; H04W 8/22; H04W 84/06

(52) U.S. Cl. CPC H04W 60/04; H04W 8/04; H04W 8/22; H04W 84/06

(57) ABSTRACT

The present invention relates to systems and techniques for managing access to non-terrestrial networks within a telecommunications network utilizing an equipment information registry (EIR). A device capability attribute indicating the minimum software version requirement for a wireless device to access the non-terrestrial network is stored within the EIR. A device software version attribute reflecting the current software version of the wireless device is stored within the EIR. A determination is made whether the wireless device meets the minimum software version requirement by comparing the device capability attribute and the device software version attribute stored in the EIR. Upon determining that the wireless device satisfies the minimum software version requirement, a home location register (HLR) or home subscriber server (HSS) is updated with an indication that the wireless device is permitted to access the non-terrestrial network.

### BACKGROUND

Terrestrial networks utilize base stations to communicate with a user equipment. Base stations can be located at the surface of the Earth and support telecommunications coverage in a surrounding area. When in a coverage region of the base station, the user equipment can connect with the base station to communicate data through the network. Non-terrestrial networks (NTNs) enable the user equipment to communicate directly with orbiting satellites. In general, satellites, when compared to base stations, provide larger coverage regions and can more easily provide coverage to remote locations. NTNs often have limited resources and may require specific access procedures to manage these resources or enable complex operations to be performed by the network. Some devices may not be updated with software that enables these access procedures, thus causing these to attempt to access the NTNs using inefficient access procedures that waste network resources or prevent proper functionality of the NTNs. Accordingly, network providers can benefit from managing device access to NTNs.

### BRIEF DESCRIPTION OF THE DRAWINGS

Detailed descriptions of implementations of the present invention will be described and explained through the use of the accompanying drawings.

FIG. 1 illustrates a wireless communications system that can implement aspects of the present technology.

FIG. 2 illustrates an example operating environment in which aspects of the present technology can be implemented.

FIG. 3 illustrates an example method in accordance with aspects of the present technology.

FIG. 4 illustrates an example computer system in which at least some aspects of the present technology can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Telecommunications networks utilize NTNs to improve network coverage. Given that NTNs are operated differently than terrestrial networks, mobile network operators (MNOs) may operate their networks more efficiently or effectively when wireless devices communicate using specific procedures or have certain functionality. For example, when wireless devices that connect to NTNs have certain established/standardized security functionality, the risk of network breaches and service disruptions can be reduced. Similarly, when each wireless device that connects to NTNs is capable of communicating using optimized access procedures, the wireless devices can utilize NTN services more efficiently, which can enhance overall user experience and service quality. In yet other aspects, NTNs can have specific regulatory requirements and industry standards that wireless devices must comply with when connected with NTNs. Many wireless devices, however, may not accept updates that enable this functionality, and MNOs generally have little ability to influence whether these wireless devices accept updates that can improve network performance. Accordingly, MNOs currently have inadequate ability to ensure efficient operation of NTNs.

To address this problem and others, the present technology provides a mechanism for managing non-terrestrial network access using an equipment information registry (EIR), which stores information about wireless devices associated with a telecommunications network. Within the EIR, an MNO can define minimum functionality that a wireless device must have to access NTNs. The minimum functionality that the wireless device must have can be defined based on a model of the wireless device (e.g., determined from a type allocation code (TAC) of the wireless device) such that any wireless device of that module must have the minimum functionality to access the NTNs. In aspects, the minimum functionality can correspond to a minimum software version that must be installed on the wireless device to enable the wireless device to operate in an optimized way (e.g., communicate with certain procedures, comply with security procedures, comply with regulatory requirements or industry standards). When provisioning network access for the wireless device, the minimum software version can be compared to a software version of the wireless device (e.g., stored in the EIR) to determine if the wireless device has the minimum software version required to communicate on the NTNs in the optimized way. If so, the wireless device can be provisioned access to the NTNs. If not, the wireless device can be prevented from accessing the NTNs. In this way, the MNO can ensure effective and efficient operation of the NTN by providing access only to devices that can communicate optimally. Denying access to wireless devices that have not downloaded updates that would enable them to optimally communicate on the network can also enable the MNO to incentivize users of these devices to install updates that can improve the operation of the network.

The wireless device can be provisioned access to the NTNs by storing a network profile in a home location register (HLR)/home subscriber server (HSS) of the telecommunications network that enables the wireless device to access the NTNs. For example, the network profile can include access permissions that specify that the wireless device is authorized to access NTNs, service entitlements that specify the services available to the wireless device on the NTNs, or authentication data that can be used to authenticate the wireless device on the NTNs. Once provisioned access using the HLR/HSS, the wireless device can be provided access to the NTNs (e.g., in response to a request for access) without accessing the EIR to determine if the wireless device has the minimum functionality.

The EIR can be updated to adjust the access provided to the wireless device. For example, the minimum functionality that the wireless device must have to access the NTNs can be updated in response to determining that the current minimum functionality does not enable the wireless device to communicate in an optimized way (e.g., the wireless device is wasting network resources or failing to comply with certain communication procedures). In such a case, the minimum software version required to access the NTNs can be updated to a more recent software version that enables the wireless device to communicate in the optimized way. The software version of the wireless device can then be compared to the updated minimum functionality to determine if the wireless device has the minimum software version, and access to the NTNs can be managed based on the determination. For example, if the wireless device does not have the minimum software version, access to the NTNs can be removed using the HLR/HSS (e.g., by altering or deleting the network profile in the HLR/HSS that provides the wireless device access to the NTNs).

The software version of the wireless device can also be updated in the EIR as the wireless device installs new software updates. For example, the MNO can receive an indication that the wireless device has performed a software update and update the software version attribute of the wireless device stored in the EIR to reflect the software update. The updated software version can then be compared to the minimum functionality required for the wireless device to access the NTNs. If the updated software version is more recent than the minimum software version, the wireless device can be provided access to the NTNs by adjusting a network profile in the HLR/HSS. In this way, the MNO can dynamically manage wireless devices’ access to NTNs.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

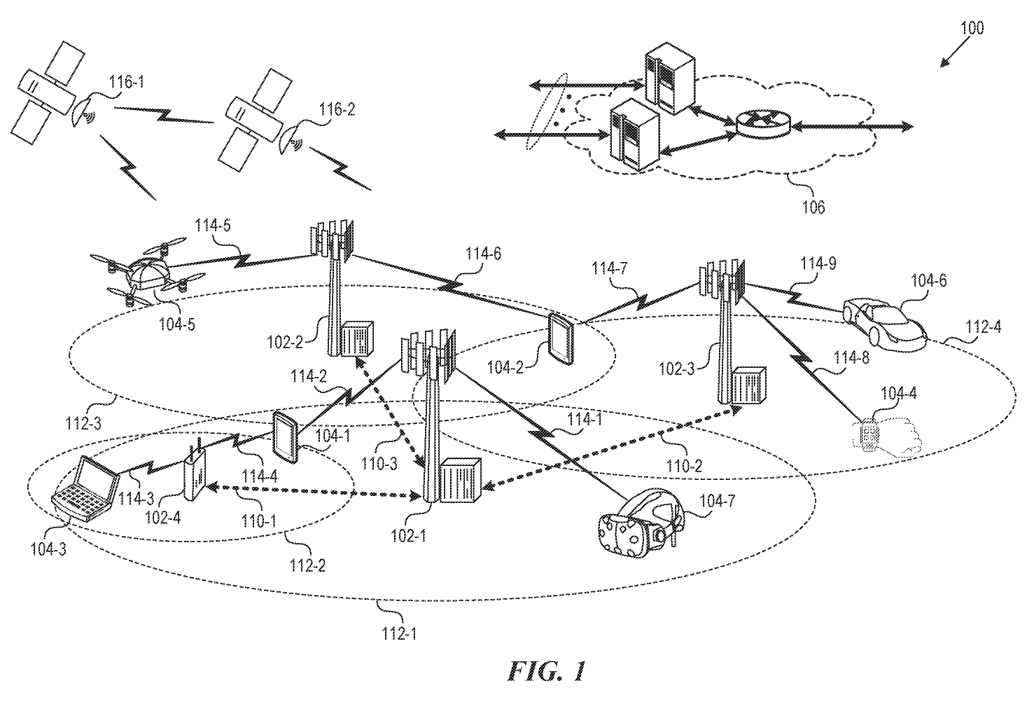

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 (Gigahertz) GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid Automatic Repeat Request (HARQ) to provide retransmission at the MAC layer to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a UE, a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of the network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The DL transmissions can also be called forward link transmissions while the UL transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, an NTN is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and core architecture to achieve Control and User Plane Separation (CUPS) and achieve extremely low user plane latency. In yet another example of 6G, the network 100 can implement a converged Wi-Fi and core architecture to increase and improve indoor coverage.

### Managing NTN Access Using an EIR

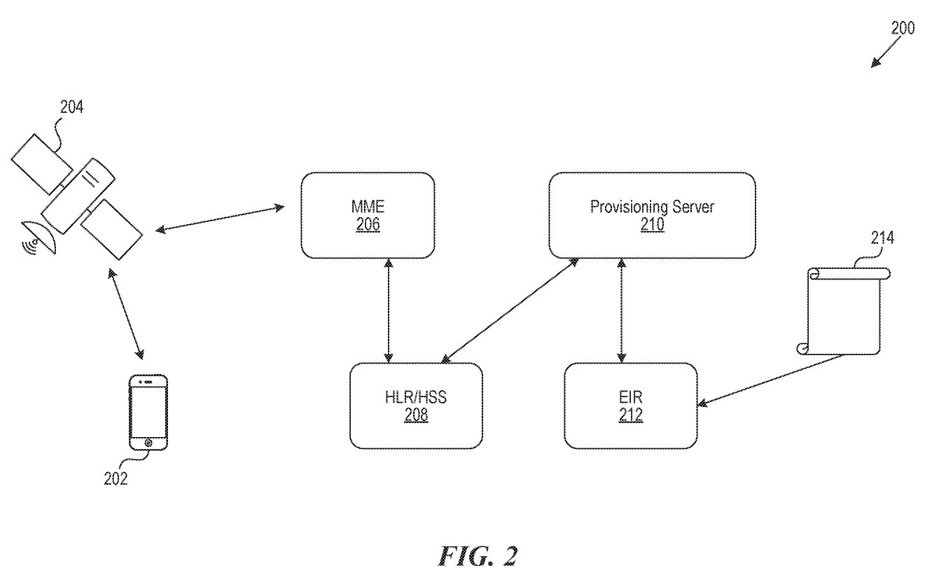

FIG. 2 illustrates an example operating environment 200 in which aspects of the present technology can be implemented. As illustrated, the environment 200 includes a wireless device 202, which can be subscribed to a telecommunications network operated by an MNO. The wireless device 202 accesses a core network of the telecommunication network through a satellite 204 implementing an NTN. In aspects, the satellite 204 can implement an NTN that is provided by the MNO or has a partnership agreement with the MNO. Thus, when access is enabled, the NTN can provide wireless services to the wireless device 202. For example, the wireless device 202 can connect to the core network of the MNO through a network gateway. As illustrated, the core network includes a Mobility Management Entity (MME) 206, an HLR/HSS 208, a provisioning server 210, and an EIR 212.

In response to a request for the wireless device 202 to access the NTN implemented through the satellite 204, the wireless device 202 can communicate device information to the MME 206 through the satellite 204. For example, the wireless device 202 can transmit an International Mobile Equipment Identity (IMEI) or International Mobile Subscriber Identity (IMSI) of the wireless device 202 to the MME 206. The MME 206 can query the HLR/HSS 208 using the device information to authenticate the wireless device 202 and retrieve subscription details associated with the wireless device 202. For example, the MME 206 can determine information about the subscriber, including their service entitlements and authentication credentials. The MME 206 can use the subscriber information from the HLR/HSS 208 to authenticate the subscriber and provide the wireless device 202 with access to any network services to which they are entitled. Once authenticated, the MME 206 maintain the authentication of the wireless device 202. For example, the MME 206 can provide access to certain networks or certain network services on the networks based on the network profiles maintained in the HLR/HSS 208. In the illustrated example, the MME 206 can maintain authentication that allows or disallows the wireless device 202 to access the NTN implemented using the satellite 204.

The HLR/HSS 208 can maintain information usable to authenticate the wireless device 202 for access to services provided by one or more networks. The HLR/HSS 208 can store a network access profile for a subscriber associated with the wireless device 202 (e.g., by the device’s IMSI). The network access profile can include the service entitlements of the subscriber. For example, the service entitlements can include a list of services the subscriber is entitled to, such as voice, SMS, data, and supplementary services (e.g., call forwarding or voicemail) or service parameters for providing the services. The network access profile can further include access permissions that define the networks to which the subscriber of the wireless device 202 is to be provided access. For example, the access permissions can include types on networks the subscriber can access (e.g., 2G, 3G, 4G, LTE, 5G, 6G, or NTNs) or any roaming permission. In some cases, the access permissions can indicate the specific networks to which the subscriber can access (e.g., identified by Public Land Mobile Network (PLMN) codes of the networks). The network access profile can further include authentication data used to authenticate the subscriber and provide services to the subscriber during network access attempts. When the wireless device 202 attempts to access a network, the MME 206 can query the HLR/HSS 208 for a network access profile associated with the subscriber of the wireless device 202 and determine the services and networks available to the wireless device 202 based on the network access profile.

The provisioning server 210 can be used to provision the network access profile associated with the subscriber. When the wireless device 202 first attempts to connect to the network provided by the MNO (e.g., during bootstrapping), the provisioning server 210 can determine the access permissions of the wireless device 202. In some cases, the provisioning server 210 can include an entitlements server that determines and manages service entitlements of the wireless device 202. The entitlements server can determine and maintain entitlement profiles for each subscriber and device. The entitlements server can be used to provision the network access profile to the subscriber within the HLR/HSS 208. The entitlements server can further update the entitlements of the subscriber based on any service updates to provide or remove, from the subscriber, access to one or more services. The entitlements server can determine any entitlements of the subscriber based on the information stored in the EIR 212.

The EIR 212 can store and manage information about wireless devices, including the wireless device 202. In aspects, the information about the wireless devices can be stored in association with their IMEIs. The EIR 212 stores detailed information about each device, such as the manufacturer, model, hardware and software versions, and network capabilities. This information can aid in network management, allowing MNOs to ensure that only compatible and authorized devices are granted access. When the wireless device 202 attempts to connect to the network provided by the MNO or when the wireless device 202 is provisioned on the network provided by the MNO for the first time, the EIR 212 can be queried to determine device information that can be used to provision a network access profile for the wireless device 202. As discussed above, the network access profile can be used to provide access to various networks or services on those networks.

Managing access to NTNs can be particularly important due to the limited resources on these networks or the specific procedures required to communicate on these networks. For example, the efficiency and effectiveness of NTNs can be improved when all wireless devices connected to the NTNs are capable of communicating in an optimized way that enables efficient resource usage, improved security, or the like. The specific procedures that optimize the NTNs can vary across MNOs based on the way in which each MNO implements their network. Thus, the overall efficiency of networks can be improved by providing MNOs the ability to control access to NTNs on their network.

This functionality can be provided through a device capability attribute 214, which can be stored in the EIR 212. The device capability attribute 214 can be defined by the MNO of the device and specify a minimum functionality that a wireless device must have to access an NTN used to access a network provided by the MNO. The device capability attribute 214 can correspond to the minimum functionality that a wireless device must have to access the NTN in an optimized way (e.g., efficiently managing network resources, providing adequate security, enabling certain pricing functions, or any other optimization of a network feature). The device capability attribute 214 can be defined based on a model of a wireless device to which the device capability attribute 214 is associated. For example, all wireless devices of the same device model can have the same device capability attribute 214, as similar models of wireless devices may require similar functionality to communicate in the optimized way because these devices have similar hardware features. In aspects, the device capability attribute 214 can be defined based on a TAC of the wireless device because the TAC can identify the hardware features of the wireless device. Thus, wireless devices having the same TAC can have the same device capability attribute 214 stored in the EIR 212.

Given that the hardware features can be defined by the device model or the TAC, the device capability attribute 214 can include a minimum software version that must be installed on the device to enable the device to communicate in the optimized way. The minimum software version can correspond to a previous software version released for the device. In some cases, the minimum software version can be specified in a format that corresponds to the naming of software versions for a particular device. For example, the minimum software version can correspond to an IMEI software version (IMEISV) of one or more versions of software released for the device (e.g., or a portion of the IMEISV that represents the software version). In this way, the minimum software version of the device capability attribute can be easily compared to an IMEISV of the device, which defines a current software version of the device, to determine whether the device includes a same or newer version of software as specified in the IMEISV.

The device capability attribute 214 can be updated to respond to new requirements of the network (e.g., new network optimizations or discoveries of new errors). For example, in response to determining that a software update that is currently sufficient to access the NTNs fails to enable a wireless device to communicate on the NTN in an optimized way, the device capability attribute 214 can be updated to require a more recent software version. When the device capability attribute 214 is updated, a previous value of the device capability attribute 214 can be replaced with the new value, and the new value can be used to determine whether a wireless device has sufficient functionality to be granted access to the NTNs.

In some cases, the device capability attribute 214 for a device or device model can be assigned by each MNO. In aspects, this can enable different MNOs to define different device capability attributes that enable devices to communicate optimally given their unique network configuration. Thus, the EIR 212 can be an EIR associated with a specific MNO. In other cases, the device capability attribute 214 can be defined across MNOs such that networks operated by different MNOs require the same device capability attribute to grant access to NTNs. In this case, the EIR 212 can be a universal EIR used across multiple MNOs.

As illustrated, the device capability attribute 214 can be stored in the EIR 212 in association with the wireless device 202 (e.g., based on an IMEI or IMSI of the wireless device 202). For example, the EIR 212 can indicate the device capability attribute 214 as an attribute of the wireless device 202. The EIR 212 further includes information about the wireless device 202. For example, the EIR 212 can include information about the model, components, or capabilities of the wireless device 202. In general, the EIR 212 includes device information, such as the IMEI, model, or status of the wireless device 202. In some cases, however, the EIR 212 can be expanded to store further information about subscribers associated with wireless devices or any other information related to the communication of the devices on a network. For example, the EIR 212 can store information about a subscriber of the wireless device 202, such as the subscribers IMSI, service plan, activity history on the network, and so on.

The EIR 212 can also store information about the functionality of the devices. For example, the hardware of the wireless device 202 can be determined from the IMEI or model information stored in the EIR 212. Information about the software installed on the wireless device 202 can also be stored in the EIR 212. For example, when the wireless device 202 first connects to or registers with the network, the wireless device 202 can have a first software version installed. Accordingly, the EIR 212 can store an indication of the first software version as the current software version of the wireless device 202. In some cases, the first software version may not be the most recent software version available for the wireless device 202 (e.g., because a user of the wireless device 202 has chosen not to install more recent software updates). Thus, the EIR 212 can maintain information to show that the wireless device 202 is operating using an older version of software available for the wireless device 202. In aspects, the software version of the wireless device 202 can be stored as an IMEISV of the wireless device 202. The IMEISV is a unique identifier used to distinguish individual mobile devices and their software versions. The IMEISV is an extension of the IMEI, which can be represented as a 15-digit number that uniquely identifies a mobile device. The IMEISV can include additional digits added to the IMEI to represent the software version number of the device. For example, the IMEISV can include two additional digits representing the software version number, making it a 17-digit number in total.

The EIR 212 can be updated to indicate up-to-date information about the wireless device 202. For example, in response to the wireless device 202 performing an update and thus having installed a different software version, the EIR 212 can be updated to reflect the current software version of the wireless device 202. The wireless device 202 can communicate its current software version at any time. For example, the wireless device 202 can communicate its current software version during a network access attempt. In other cases, the wireless device 202 can communicate its current software version through a discrete communication to the MNO. In general, when the wireless device 202 communicates its current software version (e.g., and the current software version has changed), the current software version of the wireless device 202 can be updated in the EIR 212.

The device information and the device capability attribute 214 can be used to determine whether the wireless device 202 is to be provided access to the NTN. For example, when provisioning the wireless device or in response to another triggering event where the access permissions of the wireless device 202 are determined (e.g., when the device information or the device capability attribute 214 is updated, when the access permissions of the device are provisioned, or when the wireless device 202 makes an access grant request), the device information stored in the EIR 212 in association with the wireless device 202 can be compared to the device capability attribute 214 stored in the EIR 212 in association with the wireless device 202. If the device information indicates that the wireless device 202 has the minimum functionality, the wireless device 202 can be determined to have the minimum functionality to enable the wireless device 202 to communicate in an optimized way on the NTN, and thus, can be provided access to the NTN. For example, an indication that the wireless device 202 is to be provided access to the NTN can be stored in the HLR/HSS 208 (e.g., in a network access profile of the wireless device 202 used to access the NTN). In some embodiments, storing the network access profile of the wireless device 202 in the HLR/HSS 208 can be performed by the provisioning server 210 responsible for provisioning the wireless device 202 (e.g., an entitlements server). If the wireless device 202 is not determined to have the minimum functionality to enable the wireless device 202 to communicate in an optimized way on the NTN, the wireless device 202 is not provided access to the NTN. The lack of access can be indicated in the HLR/HSS 208 by the absence of a network access profile that enables the wireless device 202 to access the NTN or an access profile that is not usable to enable the wireless device 202 to access the NTN.

The network access indicated in the HLR/HSS 208 for the wireless device 202 can be updated over time based on updates to the device information or the device capability attribute 214 of the wireless device 202. For example, if the device capability attribute 214 is updated to a newer software version, the software version of the wireless device 202 stored in the EIR 212 may no longer be sufficient to meet the requirements of the device capability attribute 214. Thus, the access to the NTN previously provided to the wireless device 202 can be rescinded by removing the indication that the wireless device 202 is to be provided access to the NTN from the HLR/HSS 208. For example, the network access profile associated with the wireless device 202 and used to access the NTN can be deleted or adjusted to render it inoperable to access the NTN. Similarly, if the wireless device 202 installs a software update, the current software version of the wireless device 202 may meet the requirements of the device capability attribute 214 needed to be provided access to the network, even if the previous software version of the wireless device 202 did not. Thus, even though NTN access was not originally provisioned to the wireless device 202, in response to determining that the more recent software version now installed on the wireless device 202 meets the requirements specified in the device capability attribute 214, the wireless device can be granted access to the NTN (e.g., by storing an indication of access in the HLR/HSS 208, for example, in a network access profile associated with the wireless device 202).

In general, the updates to the network access permissions can be triggered without specific intervention from the MNOs. For example, the network access permissions can be updated in response to trigger events, such as when the device information or the device capability attribute 214 is updated, when the access permissions of the device are provisioned, or when the wireless device 202 makes an access grant request. In other cases, the network access permissions can be updated at predetermined intervals or in response to a request from the MNO.

Once the network access permissions are provisioned for the wireless device 202, the EIR 212 need not be used to compare the functionality of the wireless device 202 against the device capability attribute to determine if the wireless device 202 is to be provided access to a network to which the wireless device 202 is requesting access. Instead, in response to an access request, for example, to the NTN implemented using satellite 204, the MME 206 can receive the request and query the HLR/HSS 208 to determine if the wireless device 202 is authorized to access the NTN. The MME 206 can query the HLR/HSS 208 for the indication that the wireless device 202 is to be provided access to the NTN. For example, the MME 206 can retrieve a network access profile associated with the wireless device 202. If the wireless device 202 was determined to have the minimum functionality to communicate in an optimized manner on the NTN and was thus provisioned access, the network access profile can be used to provide the wireless device 202 access to the NTN. If not, the wireless device 202 can be denied access to the NTN, thereby preventing any inefficiencies from granting the wireless device 202 access to the NTN when it cannot communicate in the optimized way.

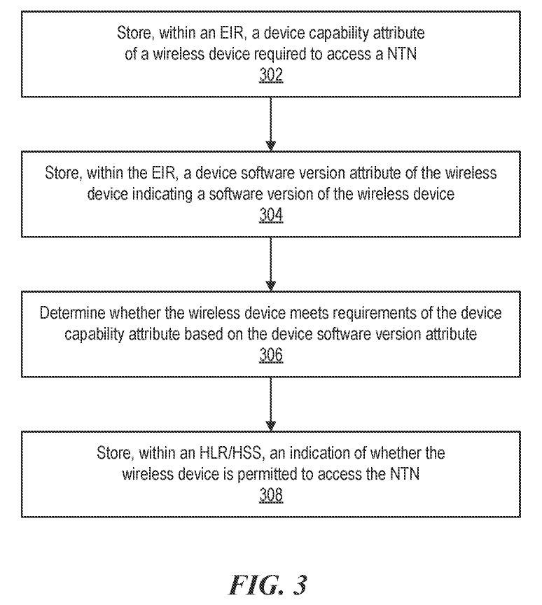

FIG. 3 illustrates an example method 300 for managing non-terrestrial network access using an EIR. Although illustrated in a particular configuration, one or more operations of the method 300 may be omitted, repeated, or reorganized. Additionally, the method 300 may include other operations not illustrated in FIG. 3—for example, operations detailed in one or more other methods described herein.

At 302, a device capability attribute of a wireless device is stored within an EIR of a telecommunications network provided by an MNO. The device capability attribute can indicate a minimum software version requirement required by the MNO to enable the wireless device to access an NTN of the telecommunications network. The device capability attribute can correspond to functionality needed by the wireless device to enable the wireless device to communicate in an optimized way on the NTN. The device capability attribute can be defined based on a model of the wireless device. Thus, the device capability attribute can specify the software or other functional requirements needed for a type of device, sharing a particular set of hardware, to communicate in an optimized way. When the MNO determines that additional functionality is needed on the wireless device to enable optimized communications or mandates new procedures from optimally communicating on the network, the device capability attribute can be updated.

At 304, a device software version attribute of the wireless device indicating a software version of the wireless device is stored within the EIR. The device software version attribute can indicate a most recent software version installed on the wireless device and communicated to the MNO. The software version of the wireless device can be communicated during provisioning of the device, during an access attempt, or at any other time. The device software version attribute can be updated as the device performs additional software updates. In aspects, the device software version attribute can correspond to an IMEISV of the wireless device.

At 306, a determination is made whether the wireless device meets the requirements of the device capability attribute based on the device software version attribute. For example, the device capability attribute of the wireless device and the device software version attribute of the wireless device can be retrieved from the EIR and compared to determine if the wireless device has installed a version of software that is as recent as or newer than the minimum software version required by the device capability attribute. In aspects, the device software version attribute can be an IMEISV, and thus can be compared directly to the minimum software version indicated in the device capability attribute. For example, a portion of the IMEISV that indicates the software version of the wireless device can be compared to the minimum software version indicated in the device capability attribute, which can have a similar format as an IMEISV, to determine if the portion of the IMEISV that indicates the software version is greater than or equal to the minimum software version. If so, the wireless device can be determined to have the minimum functionality required to satisfy the device capability attribute.

At 308, an indication of whether the wireless device is permitted to access the NTN is stored in the HLR/HSS based on the determination made at 306. For example, if the wireless device is determined to have the minimum functionality to satisfy the device capability attribute and thus is capable of communicating on the NTN in the optimized way, the wireless device can be provided access to the NTN. If not, the wireless device is not permitted access to the NTN. The access can be provided to the wireless device by storing a network access profile in the HLR/HSS that can be used to authenticate the wireless device for services on the NTN. Then, in response to a future request from the wireless device to access the NTN, the network access profile can be retrieved from the HLR/HSS to be used to connect the wireless device to the NTN. If the access was not provided in the HLR/HSS because the wireless device did not have the minimum functionality and thus would communicate inefficiently, the wireless device can be prevented from accessing the NTN, thereby preventing any suboptimal effect that would arise from enabling the wireless device to connect to the NTN and communicate in an unoptimized manner.

### Computer System

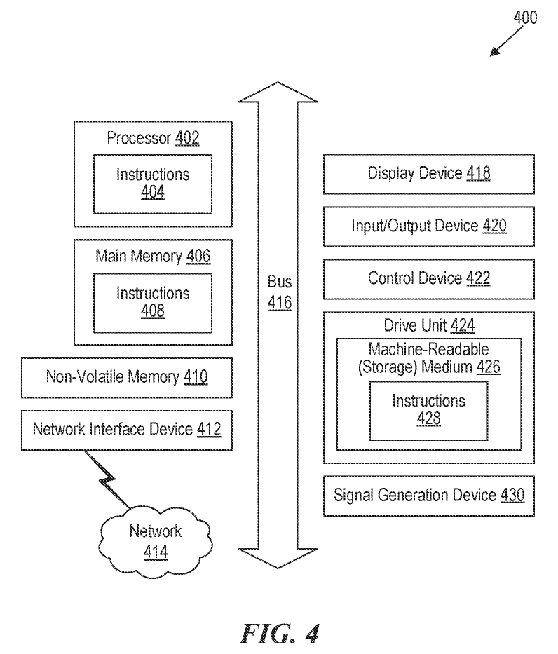

FIG. 4 is a block diagram that illustrates an example of a computing system 400 in which at least some operations described herein can be implemented. As shown, the computing system 400 can include one or more processors 402, main memory 406, non-volatile memory 410, a network interface device 412, a display device 418, an input/output device 420, a control device 422 (e.g., keyboard and pointing device), a drive unit 424 that includes a machine-readable (storage) medium 426, and a signal generation device 430 that are communicatively connected to a bus 416. The bus 416 represents one or more physical buses and/or point-to-point connections that are connected by appropriate bridges, adapters, or controllers. Various common components (e.g., cache memory) are omitted from FIG. 4 for brevity. Instead, the computing system 400 is intended to illustrate a hardware device on which components illustrated or described relative to the examples of the figures and any other components described in this specification can be implemented.

The computing system 400 can take any suitable physical form. For example, the computing system 400 can share a similar architecture as that of a server computer, personal computer (PC), tablet computer, mobile telephone, game console, music player, wearable electronic device, network-connected (“smart”) device (e.g., a television or home assistant device), AR/VR system (e.g., head-mounted display), or any electronic device capable of executing a set of instructions that specifies action(s) to be taken by the computing system 400. In some implementations, the computing system 400 can be an embedded computing system, a system-on-chip (SOC), a single-board computing (SBC) system, or a distributed system such as a mesh of computing systems, or it can include one or more cloud components in one or more networks. Where appropriate, one or more computing systems 400 can perform operations in real time, in near real time, or in batch mode.

The network interface device 412 enables the computing system 400 to mediate data in a network 414 with an entity that is external to the computing system 400 through any communication protocol supported by the computing system 400 and the external entity. Examples of the network interface device 412 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 406, non-volatile memory 410, machine-readable (storage) medium 426) can be local, remote, or distributed. Although shown as a single medium, the machine-readable (storage) medium 426 can include multiple media (e.g., a centralized/distributed database and/or associated caches and servers) that store one or more sets of instructions 428. The machine-readable (storage) medium 426 can include any medium that is capable of storing, encoding, or carrying a set of instructions for execution by the computing system 400. The machine-readable (storage) medium 426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in computing device(s). When read and executed by the processor 402, the instruction(s) cause the computing system 400 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A method comprising:
storing, within an equipment information registry (EIR) of a telecommunications network, a device capability attribute of a wireless device indicating a minimum software version requirement required by a mobile network operator (MNO) of the telecommunications network to enable the wireless device to access a non-terrestrial network of the telecommunications network,
wherein the device capability attribute is defined based on a device model of the wireless device;
storing, within the EIR of the telecommunications network, a device software version attribute of the wireless device indicating a software version of the wireless device;
receiving, from the EIR of the telecommunications network, the device capability attribute of the wireless device and the device software version attribute of the wireless device;
determining, based on the device capability attribute of the wireless device and the device software version attribute of the wireless device, that the wireless device satisfies the minimum software version requirement required by the MNO to access the non-terrestrial network of the telecommunications network; and
in response to determining that the wireless device satisfies the minimum software version requirement required by the MNO to access the non-terrestrial network of the telecommunications network, storing, within a home location register (HLR) or home subscriber server (HSS) of the telecommunications network, an indication that the wireless device is permitted to access the non-terrestrial network of the telecommunications network.

2. The method of claim 1, further comprising:
updating, within the EIR of the telecommunications network, the device capability attribute of the wireless device to indicate an updated minimum software version requirement required by the MNO of the telecommunications network to enable the wireless device to access the non-terrestrial network of the telecommunications network;
determining, based on the device capability attribute of the wireless device and the device software version attribute of the wireless device, that the wireless device does not meet the updated minimum software version requirement required by the MNO to access the non-terrestrial network of the telecommunications network; and
in response to determining that the wireless device does not meet the updated minimum software version requirement required by the MNO to access the non-terrestrial network of the telecommunications network, removing, from the HLR or HSS of the telecommunications network, the indication that the wireless device is permitted to access the non-terrestrial network of the telecommunications network.

3. The method of claim 1, wherein:
the device software version attribute of the wireless device comprises an International Mobile Equipment Identity Software Version (IMEISV) of the wireless device; and
determining that the wireless device meets the minimum software version requirement required by the MNO to access the non-terrestrial network of the telecommunications network comprises determining that a software version indicated in the IMEISV of the wireless device is greater than or equal to the minimum software version indicated in the device capability attribute of the wireless device.

4. The method of claim 1, wherein the device capability attribute of the wireless device is defined based on the Type Allocation Code (TAC) of the wireless device.

5. The method of claim 1, further comprising:
receiving a request for the wireless device to access the non-terrestrial network of the telecommunications network;
in response to receiving the request for the wireless device to access the non-terrestrial network of the telecommunications network, determining that the HLR or HSS of the telecommunications network stores the indication that the wireless device is permitted to access the non-terrestrial network of the telecommunications network; and
in response to determining that the HLR or HSS of the telecommunications network stores the indication that the wireless device is permitted to access the non-terrestrial network of the telecommunications network, providing the wireless device access to the non-terrestrial network of the telecommunications network.

6. The method of claim 1, wherein determining that the wireless device meets the minimum software version requirement required by the MNO to access the non-terrestrial network of the telecommunications network is performed by an entitlements server of the telecommunications network.

7. The method of claim 1, further comprising updating, in the EIR of the telecommunications network, the device software version attribute of the wireless device in response to receiving an indication that a current software version of the wireless device has changed.

8. A system comprising:
at least one hardware processor; and
at least one non-transitory memory storing instructions that, when executed by the at least one hardware processor, cause the system to:
store, within an equipment information registry (EIR) of a telecommunications network, a device capability attribute of a wireless device indicating a software version requirement required by a mobile network operator (MNO) of the telecommunications network to enable the wireless device to access a non-terrestrial network of the telecommunications network;
store, within the EIR of the telecommunications network, a device software version attribute of the wireless device indicating a software version of the wireless device;
determine, based on the device capability attribute of the wireless device and the device software version attribute of the wireless device stored in the EIR of the telecommunications network, whether the wireless device satisfies the software version requirement required by the MNO to access the non-terrestrial network of the telecommunications network; and
in response to determining that the wireless device satisfies the software version requirement required by the MNO to access the non-terrestrial network of the telecommunications network, provide, within a home location register (HLR) or home subscriber server (HSS) of the telecommunications network, an indication that the wireless device is permitted to access the non-terrestrial network of the telecommunications network.

9. The system of claim 8, wherein the system is further caused to:
receive an indication that a current software version of the wireless device has changed from a first software version to a second software version;
in response to receiving the indication that the current software version of the wireless device has changed from the first software version to the second software version, update, within the EIR of the telecommunications network, the device software version attribute of the wireless device to indicate the second software version;
after updating the device software version attribute of the wireless device to indicate the second software version attribute, determine, based on the updated device capability attribute of the wireless device and the device software version attribute of the wireless device, whether the wireless device meets the minimum software version requirement required by the MNO to access the non-terrestrial network of the telecommunications network; and
in response to determining that the wireless device meets the minimum software version requirement required by the MNO to access the non-terrestrial network of the telecommunications network, provide, within the HLR or HSS of the telecommunications network, the indication that the wireless device is permitted to access the non-terrestrial network of the telecommunications network.

10. The system of claim 8, wherein the system is further caused to:
update, within the EIR of the telecommunications network, the device capability attribute of the wireless device to indicate an updated minimum software version requirement required by the MNO of the telecommunications network to enable the wireless device to access the non-terrestrial network of the telecommunications network;
after updating the device capability attribute of the wireless device to indicate the updated minimum software version requirement, determine, based on the device capability attribute of the wireless device and the device software version attribute of the wireless device, whether the wireless device meets the updated minimum software version requirement;
in response to determining that the wireless device meets the minimum software version requirement, provide, within the HLR or HSS of the telecommunications network, the indication that the wireless device is permitted to access the non-terrestrial network of the telecommunications network; and
in response to determining that the wireless device does not meet the minimum software version requirement required by the MNO to access the non-terrestrial network of the telecommunications network, not provide, within the HLR or HSS of the telecommunications network, the indication that the wireless device is permitted to access the non-terrestrial network of the telecommunications network.

11. The system of claim 8, wherein:
the device software version attribute of the wireless device comprises an International Mobile Equipment Identity Software Version (IMEISV) of the wireless device; and
determining that the wireless device meets the minimum software version requirement required by the MNO to access the non-terrestrial network of the telecommunications network comprises determining that a software version indicated in the IMEISV of the wireless device is greater than or equal to the minimum software version indicated in the device capability attribute of the wireless device.

12. The system of claim 8, wherein the device capability attribute is defined based on a device model of the wireless device.

13. The system of claim 8, wherein the device capability attribute is defined based on the Type Allocation Code (TAC) of the wireless device.

14. The system of claim 8, wherein the system is further caused to:
receive a request for the wireless device to access the non-terrestrial network of the telecommunications network;
in response to receiving the request for the wireless device to access the non-terrestrial network of the telecommunications network, determine whether the HLR or HSS of the telecommunications network includes the indication that the wireless device is permitted to access the non-terrestrial network of the telecommunications network; and
in response to determining that the HLR or HSS of the telecommunications network includes the indication that the wireless device is permitted to access the non-terrestrial network of the telecommunications network, provide the wireless device access to the non-terrestrial network of the telecommunications network.

15. The system of claim 8, wherein determining that the wireless device meets the minimum software version requirement required by the MNO to access the non-terrestrial network of the telecommunications network is performed using an entitlements server of the telecommunications network.

16. At least one non-transitory, computer-readable storage medium storing instructions that, when executed by at least one processor, cause the at least one processor to:
store, within an equipment information registry (EIR) of a telecommunications network, a device capability attribute of a wireless device indicating a minimum software version requirement required by a mobile network operator (MNO) of the telecommunications network to enable the wireless device to access a non-terrestrial network of the telecommunications network;
store, within the EIR of the telecommunications network, a device software version attribute of the wireless device indicating a software version of the wireless device;
determine, based on the device capability attribute of the wireless device and the device software version attribute of the wireless device stored in the EIR of the telecommunications network, whether the wireless device meets the minimum software version requirement required by the MNO to access the non-terrestrial network of the telecommunications network; and
in response to determining that the wireless device meets the minimum software version requirement required by the MNO to access the non-terrestrial network of the telecommunications network, indicate, within a home location register (HLR) or home subscriber server (HSS) of the telecommunications network, that the wireless device is permitted to access the non-terrestrial network of the telecommunications network.

17. The non-transitory, computer-readable storage medium of claim 16, wherein the at least one processor is further caused to:
update, within the EIR of the telecommunications network, the device capability attribute of the wireless device to indicate an updated minimum software version requirement required by the MNO of the telecommunications network to enable the wireless device to access the non-terrestrial network of the telecommunications network;
after updating the device capability attribute of the wireless device to indicate the updated minimum software version requirement required by the MNO to access the non-terrestrial network of the telecommunications network, determine, based on the device capability attribute of the wireless device and the device software version attribute of the wireless device, that the wireless device meets the updated minimum software version requirement required by the MNO to access the non-terrestrial network of the telecommunications network; and
in response to determining that the wireless device meets the minimum software version requirement required by the MNO to access the non-terrestrial network of the telecommunications network, indicate, within the HLR or HSS of the telecommunications network, that the wireless device is permitted to access the non-terrestrial network of the telecommunications network.

18. The non-transitory, computer-readable storage medium of claim 16, wherein the at least one processor is further caused to:
update, within the EIR of the telecommunications network, the device capability attribute of the wireless device to indicate an updated minimum software version requirement required by the MNO of the telecommunications network to enable the wireless device to access the non-terrestrial network of the telecommunications network;
after updating the device capability attribute of the wireless device to indicate the updated minimum software version requirement, determine, based on the device capability attribute of the wireless device and the device software version attribute of the wireless device, whether the wireless device meets the updated minimum software version requirement; and
in response to determining that the wireless device does not meet the minimum software version requirement, not indicate, within the HLR or HSS of the telecommunications network, that the wireless device is permitted to access the non-terrestrial network of the telecommunications network.

19. The non-transitory, computer-readable storage medium of claim 16, wherein:
the device software version attribute of the wireless device comprises an International Mobile Equipment Identity Software Version (IMEISV) of the wireless device; and
determining that the wireless device meets the minimum software version requirement required by the MNO to access the non-terrestrial network of the telecommunications network comprises determining that a software version indicated in the IMEISV of the wireless device is greater than or equal to the minimum software version indicated in the device capability attribute of the wireless device.

20. The non-transitory, computer-readable storage medium of claim 16, wherein the device capability attribute is defined based on the Type Allocation Code (TAC) of the wireless device.
